(19) United States
(12) Patent Application Publication
(10) Pub. No.: US 2023/0405539 A1
(43) Pub. Date: Dec. 21, 2023

(54) CONTROL METHOD OF CARBONATED WATER MACHINE AND CARBONATED WATER MACHINE

(71) Applicant: C18 LLC, Lake Worth, FL (US)

(72) Inventor: Yao FENG, LAKE WORTH, FL (US)

(73) Assignee: C18 LLC, LAKE WORTH, FL (US)

(21) Appl. No.: 17/843,726

(22) Filed: Jun. 17, 2022

(51) Int. Cl. B01F 35/22; B01F 23/237; B01F 35/71; B01F 23/233; C02F 1/32; C02F 1/02; B01F 35/221; A23L 2/54

(52) U.S. Cl. CPC B01F 35/2206; B01F 23/23762; B01F 35/71805; B01F 23/233; C02F 1/32; B67D 1/0071; B01F 35/2216; B01F 35/2217; B01F 35/7176; A23L 2/54; C02F 1/02

(57) ABSTRACT

A control method of a carbonated water machine and a carbonated water machine are provided. The carbonated water machine includes a mixer, a liquid supply assembly, and a gas supply assembly. A mixing cavity is formed in the mixer, and the mixer is provided with a gas-liquid inlet and an outlet connected to the mixing cavity, a liquid outlet of the liquid supply assembly and a gas outlet of the gas supply assembly are both connected to the gas-liquid inlet, the control method includes: receiving a carbonated water production instruction; and turning on the liquid supply assembly to inject liquid into the mixing cavity, and turning on the gas supply assembly to inject carbon dioxide into the mixing cavity, so that the liquid and the carbon dioxide are mixed in the mixing cavity to form carbonated water. The present application can improve a convenience of carbonated water production.

### TECHNICAL FIELD

The present application relates to the technical field of carbonated water production, in particular to a control method of a carbonated water machine and a carbonated water machine.

### BACKGROUND

The existing carbonated water machines on the market pour high-pressure CO2 gas into PET plastic bottles, and use high-pressure impact cold water in bottles to make carbonated water. This production method is not safe and convenient enough, and has requirements on water level in the pressure water bottle, and the plastic bottle is used as a high-pressure container, which is prone to the risk of explosion. After the production is completed, the carbonated water in the bottle needs to be distributed to the cups, and the operation process is complicated.

### SUMMARY

The main purpose of the present application is to provide a control method of a carbonated water machine and a carbonated water machine using the control method to improve convenience of making carbonated water.

In order to achieve the above purpose, the present application proposes a control method of a carbonated water machine, the carbonated water machine comprises a mixer, a liquid supply assembly, and a gas supply assembly, a mixing cavity is formed in the mixer, and the mixer is provided with a gas-liquid inlet and an outlet connecting with the mixing cavity, a liquid outlet of the liquid supply assembly and a gas outlet of the gas supply assembly are both communicated with the gas-liquid inlet, and the control method of the carbonated water machine comprises:
receiving a carbonated water production instruction; and
turning on the liquid supply assembly to inject liquid into the mixing cavity, and turning on the gas supply assembly to inject carbon dioxide into the mixing cavity, so that the liquid and the carbon dioxide are mixed in the mixing cavity to form carbonated water.

In one embodiment, the liquid supply assembly comprises a water tank, a water pump and a three-way control valve, the three-way control valve is configured with a water inlet, a first water outlet and a second water outlet, the water inlet is connected to the water tank through the water pump, the first water outlet is connected to the water tank, and the second water outlet is connected to the gas-liquid inlet;
wherein the operation of opening the liquid supply assembly to inject liquid into the mixing cavity comprises:
controlling an inner side of the three-way control valve to form a passage from the water inlet to the first water outlet;
turning on the water pump, controlling the inner side of the three-way control valve to cut off the passage from the water inlet to the first water outlet in responding to that the water pump is turned on for a first preset turn-on time duration, and forming a passage from the water inlet to the second water outlet to inject the liquid into the mixing cavity.

In one embodiment, the passage from the water inlet to the first water outlet further comprises:
turning on a sterilization assembly to sterilize the water tank.

In one embodiment, after the operation of turning on the sterilization assembly, the method further comprises:
detecting an installation state of the water tank;
generating an instruction to turn on the sterilization assembly in responding to that the water tank is installed in place.

In one embodiment, after the operation of turning on the sterilization assembly, the method further comprises:
turning off the sterilization assembly in responding to that the sterilization assembly is turned on for a second preset turn-on time duration;
repeating the operation of turning on the sterilization assembly in responding to that the sterilization assembly is turned off for a preset turn-off time duration.

In one embodiment, in the operation of turning on the liquid supply assembly to inject the liquid into the mixing cavity and tuning on the gas supply assembly to inject the carbon dioxide into the mixing cavity, the liquid injected by the liquid supply assembly into the mixing cavity and the carbon dioxide injected by the gas supply assembly are within a same pressure range.

In one embodiment, a pressure range of the liquid and the carbon dioxide injected into the mixing cavity is 6 kg/cm2 to 8 kg/cm2.

In one embodiment, after the operation of turning on the liquid supply assembly to inject the liquid into the mixing cavity and turning on the gas supply assembly to inject the carbon dioxide into the mixing cavity, so that the liquid and the carbon dioxide are mixed in the mixing cavity to form the carbonated water, the method further comprises:
controlling the liquid supply assembly and the gas supply assembly to stop operation in responding to that a preset stop condition is met.

In one embodiment, the operation of controlling the liquid supply assembly and the gas supply assembly to stop operation comprises:

controlling the liquid supply assembly to stop operation;
controlling the gas supply assembly to stop operation after the liquid supply assembly is stopped for a preset stop time duration.

The present application further provides a carbonated water machine, wherein the carbonated water machine comprises a mixer, a liquid supply assembly and a gas supply assembly, a mixing cavity is formed in the mixer, and the mixer is provided with a gas-liquid inlet and an outlet both communicating with the mixing cavity, and a liquid outlet of the liquid supply assembly and a gas outlet of the gas supply assembly are both connected with the gas-liquid inlet;
wherein the carbonated water machine further comprises a memory, a processor, and a control program of the carbonated water machine stored in the memory and operable on the processor, and when the control program of the carbonated water machine is executed by the processor, the processor implements the control method of the carbonated water machine above.

The technical solution of the present application is to inject liquid and carbon dioxide from the gas-liquid inlet of the mixer into the mixing cavity of the mixer at the same time through the liquid supply assembly and the gas supply assembly, so as to form carbonated water in the mixing cavity, and the carbonated water sequentially flow out from the carbonated water machine through an outlet for a user to drink. The embodiment of the present application completely cancels the pressure tank, and adopts a method of instant mixing, the user can directly take the carbonated water at a flow outlet of the carbonated water machine without other operations, which improves convenience for the use of the carbonated water machine.

### BRIEF DESCRIPTION OF THE DRAWINGS

In order to more clearly illustrate the technical solutions in the embodiments of the present application or in the related art, the following will briefly introduce the accompanying drawings that need to be used in the description of the embodiments or the related art. Obviously, the accompanying drawings in the following description are only some embodiments of the present application. For those of ordinary skill in the art, without creative labor, other drawings can further be obtained according to the structure shown in these drawings.

FIG. 1 is a structural diagram of a terminal of a hardware operating environment involved in an embodiment of the present application.

FIG. 2 is a flow chart of a first embodiment of a control method of a carbonated water machine of the present application.

FIG. 3 is a flow chart of a second embodiment of the control method of the carbonated water machine of the present application.

FIG. 4 is a flow chart of a third embodiment of the control method of the carbonated water machine of the present application.

FIG. 5 is a flow chart of a fourth embodiment of the control method of the carbonated water machine of the present application.

FIG. 6 is a flow chart of a fifth embodiment of the control method of the carbonated water machine of the present application.

FIG. 7 is a flow chart of the sixth embodiment of the control method of the carbonated water machine of the present application.

FIG. 8 is a control schematic diagram of the carbonated water machine according to an embodiment of the present application.

FIG. 9 is an isometric view of the carbonated water machine according to an embodiment of the present application.

FIG. 10 is an isometric view of the carbonated water machine of the present application, with a side cover plate is removed.

FIG. 11 is an isometric view of the carbonated water machine according to an embodiment of the present application.

FIG. 12 is a cross-sectional view of a gas cylinder and an ejection mechanism of the present application.

FIG. 13 is an isometric view of a mixer according to an embodiment of the application mixer.

FIG. 14 is an isometric view of the mixer with a cover is removed.

FIG. 15 is a cross-sectional view of the mixer.

FIG. 16 is a cross-sectional view of the mixer, viewed from another direction.

FIG. 17 is a schematic diagram of a water hammer effect of the mixer.

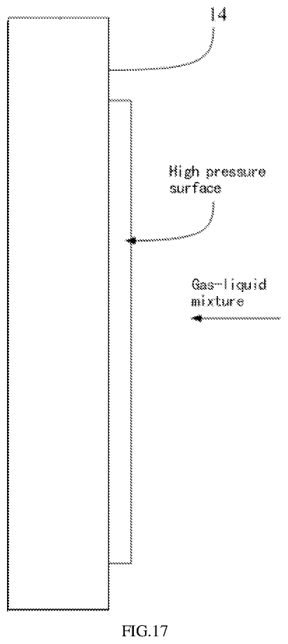

The realization of the objective, functional characteristics and advantages of the present application will be further described with reference to the drawings in conjunction with the embodiments.

### DETAILED DESCRIPTION OF THE EMBODIMENTS

It should be understood that the specific embodiments described herein are only used to explain the present application and are not used to limit the present application.

In order to better understand the above technical solutions, exemplary embodiments of the present disclosure will be described in more detail below with reference to the accompanying drawings. Although exemplary embodiments of the present disclosure are shown in the drawings, it should be understood that the present disclosure may be implemented in various forms and should not be limited by the embodiments set forth herein. On the contrary, these embodiments are provided so that the present disclosure can be more thoroughly understood and the scope of the present disclosure can be fully communicated to those skilled in the art.

The present application provides a control method of a carbonated water machine 100, which is applied to a carbonated water machine 100, the carbonated water machine 100 includes a mixer 10, a liquid supply assembly 20, and a gas supply assembly 30. The mixer 10 is formed with a mixing cavity 113, and the mixer 10 is provided with a gas-liquid inlet 1111 and an output port 1112 connected to the mixing cavity 113, a liquid outlet of the liquid supply assembly 20 and a gas outlet 321 of the gas supply assembly 30 are both communicated with the gas-liquid inlet 1111.

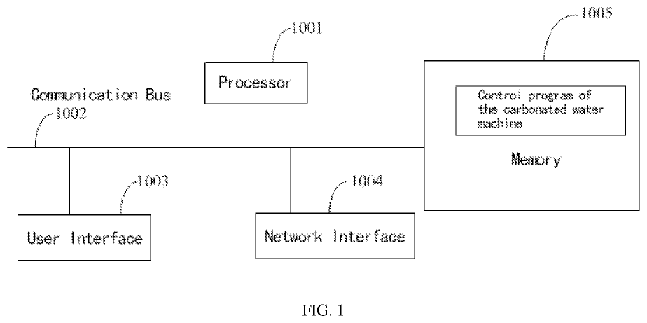

FIG. 1 is a schematic structural diagram of a terminal of an operating environment of the carbonated water machine 100 involved in an embodiment of the present application. The terminal may include a processor 1001, such as a CPU, a network interface 1004, a user interface 1003, a memory 1005, and a communication bus 1002. The communication bus 1002 is configured to realize the connection and communication between these assemblies. The user interface 1003 may include a display screen (Display), an input unit such as a keyboard (Keyboard), and the user interface 1003 may optionally further include a standard wired interface and a wireless interface. The network interface 1004 can optionally include a standard wired interface and a wireless interface (such as a WI-FI interface). The memory 1005 can be a high-speed RAM memory or a stable volatile memory, such as a disk memory. The memory 1005 may optionally further be a storage device independent of the aforementioned processor 1001.

Those skilled in the art can understand that the terminal structure shown in FIG. 1 does not constitute a limitation on the carbonated water machine 100, which may include more or fewer modules than shown, or have certain modules combined, or have a different assembly arrangement.

According to FIG. 1, the memory 1005, as a computer-readable storage medium, may include an operating system, a network communication module, a user interface module, and a control method of the carbonated water machine 100.

In the terminal according to FIG. 1, the network communication module is mainly configured for data communication with a backend server, the user interface module is mainly configured for data communication with the client (user side), and the processor 1001 can be configured to call the control method of the carbonated water machine 100 in the memory 1005, and perform the following operations:

Operation S10, receiving a carbonated water production instruction.

Operation 520, opening the liquid supply assembly 20 to inject liquid into the mixing cavity 113, and opening the gas supply assembly 30 to inject carbon dioxide into the mixing cavity 113, so that the liquid and the carbon dioxide are mixed in the mixing cavity 113 to form carbonated water.

In an embodiment, the carbonated water machine 100 proposed in the present application is configured to dissolve carbon dioxide in water to prepare carbonated water. The carbonated water machine 100 includes a machine base 40 as an installation basis, and a liquid supply assembly 20 and a gas supply assembly 30 arranged on the base 40, and a mixer 10 for mixing gas and liquid, the liquid supply assembly 20 and the gas supply assembly 30 are both communicated with the gas and liquid inlet 1111 of the mixer 10, to inject liquid and carbon dioxide into the mixing cavity 113 of the mixer 10. It is understandable that the carbonated water machine 100 is equipped with a processor and a memory, which are mainly integrated on a control main board. The liquid supply assembly 20 and the gas supply assembly 30 on the carbonated water machine 100 are electrically connected to the processor through a communication bus. The memory stores the control program of the carbonated water machine 100, the processor may invoke the control program stored in the memory. Generally, a control system 60 includes a main board and a control key 62. The main board is provided with an operating program of the carbonated water machine 100, the control key 62 can be a physical key or a touch key, a user inputs instructions through the control key 62, and the processor controls the corresponding assemblies to perform corresponding actions after analyzing and processing the control instructions. For example, when the processor receives the carbonated water production instruction, the processor controls the liquid supply assembly 20 to inject liquid and the gas supply assembly 30 to inject carbon dioxide into the mixer 10 at the same time, so that the water and carbon dioxide can be fully contacted in the mixing chamber 113, increasing a contact area between water and carbon dioxide, the mixing method of mixing water and gas in the mixing chamber 113 can result in that the water and the gas enters with a preset pressure, approximately 6 kg/cm2-8 kg/cm2 of carbon dioxide and liquid enter the mixing chamber 113, so that the mixing chamber 113 meet the preset pressure and allow the water and the gas to mix, or a water hammer effect can further be used to make the water and the gas impact on an impact interface 114 in the mixing chamber 113, thereby generating high pressure at the moment of impact to promote water and gas mixing. The gas supply assembly 30, the liquid supply assembly 20, the mixer 10 and the control main board can all be arranged on the machine base 40. The machine base 40 includes a main part 41 and an extension part 42. A mounting cavity 44 is formed in the main part 41 for installing the liquid supply assembly 20, the gas supply assembly 30 and the mixer 10. The extension part 42 is extended outward from a top side wall of main part 41 and provided with a flow outlet. the flow outlet is connected with an outlet 1112 of the mixer 10, and the carbonated water after the water and gas are mixed directly flows out for the user to drink. The flow outlet can be an outward extending water pipe, the water pipe can be pulled to a desired position, and the flow outlet can further be directly opened on a bottom wall of the extension part 42, so that the flow outlet is arranged downward, and the user can get the carbonated water. It should be noted that, in this embodiment, a gas cylinder 31 of the gas supply assembly 30 may be directly disposed in the machine base 40, or be externally disposed, and likewise the water tank 21 of the liquid supply assembly 20 may be place in the machine base 40, or an external water source can be adopted, which is not limited herein.

In some embodiments, the control system 60 further includes a power supply assembly 61, the power supply assembly 61 may provide power for the liquid supply assembly 20 and the gas supply assembly 30, and the power supply assembly may be a battery provided on the carbonated water machine 100, or may be a power supply interface provided on the carbonated water machine 100, which is not limited herein.

Therefore, it can be understood that the technical solution of the present application is to simultaneously inject liquid and carbon dioxide from a gas-liquid inlet 1111 of the mixer 10 into the mixing cavity 113 of the mixer 10 through the liquid supply assembly 20 and the gas supply assembly 30, so as to form carbonated water 113 in the mixing cavity, and sequentially flow out from the carbonated water machine 100 through the outlet 1112 for the user to drink. The technical scheme of the present application completely omits a pressure tank, and adopts the method of instant mixing, the user can directly take carbonated water at the flow outlet of the carbonated water machine 100 without other operations, and improves the convenience of using the carbonated water machine 100.

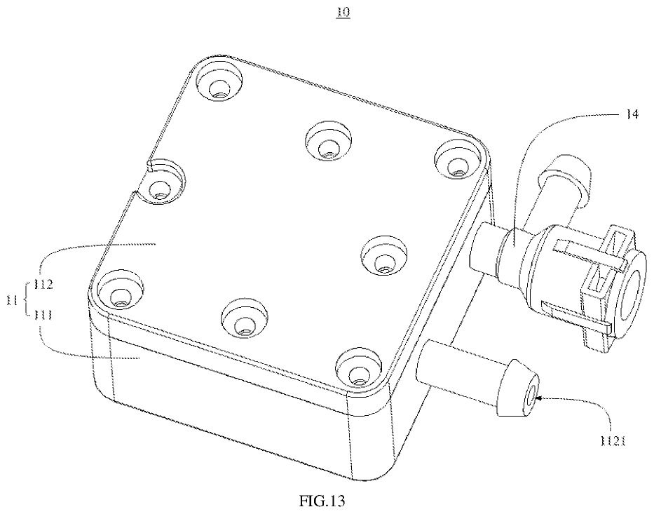

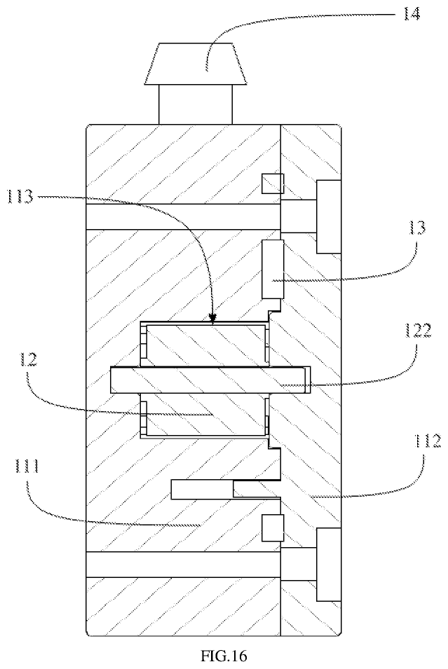

According to FIGS. 13 to 16, in an embodiment of the control method of the carbonated water machine 100 of the present application, the impact interface 114 is formed in the mixing cavity 113, so that liquid and carbon dioxide impact and mix on the impact interface 114 to form carbonated water.

In this embodiment, the mixing cavity 113 of the mixer 10 is provided with an impact interface 114, and the gas-liquid mixture with a preset pressure is injected into the mixing cavity 113 through the gas-liquid inlet 1111, so that the gas-liquid mixture can collide at the impact interface 114 and instantly stand still or change a flow direction, thus, it is possible to generate an instantaneous pressure several times the normal pressure under the action of inertia, so that carbon dioxide can be better dissolved in the liquid, and carbonated water with high solute concentration is obtained. After carbonated water with high solute concentration is obtained, the carbonated water can be discharged out of the mixing cavity 113 through the outlet 1112.

In an embodiment, a high-speed moving gas-liquid mixture itself has a certain momentum, so that carbon dioxide and liquid with a strong pressure of 6-8 kg/cm2 simultaneously impact on the impact interface 114 in the mixing cavity 113, and part of the gas-liquid mixture impact on the impact interface 114 will stop flowing instantly, while other parts of the gas-liquid mixture adjacent to this part of the gas-liquid mixture will still maintain the original state of motion due to inertial action, thus, it is possible to compress the part of the gas-liquid mixture impinging on the impact interface 114, so as to form a high pressure surface with high energy density and very high local pressure at the impact interface 114. As mentioned above, when a flow rate of a fluid moving at a high speed in a pressurized pipeline changes sharply, it will generate an instantaneous pressure several times the normal pipeline pressure in the pipe wall in a short time due to the effect of inertia, which is called a water hammer effect. This application uses the water hammer effect to generate a collision at the impact interface 114 by gas-liquid mixture, instantly producing a dissolution pressure much higher than the normal pressure, to improve solubility of the carbon dioxide in the liquid, which is based on the momentum theorem.

Specifically, the impulse formula can be:

I=Ft

The momentum formula can be:

p=mV

According to the momentum theorem, in a certain time interval, an impulse of the resultant force on a particle is equal to the momentum change of the particle at this time. From this, the momentum conservation equation can be derived:

Ft=mV

In the above equation:
I is the impulse of the gas-liquid mixture;
p is the momentum of the gas-liquid mixture;
F is the force of the gas-liquid mixture on the impact interface 114;
T is the action time of the gas-liquid mixture on the impact interface 114
m is the mass of the gas-liquid mixture;
V is the flow rate of the gas-liquid mixture.

It can be seen that when the momentum of the gas-liquid mixture changes to a certain level, the shorter the action time of the gas-liquid mixture on the impact interface 114, the greater the force of the gas-liquid mixture on the impact interface 114. Therefore, when the high-speed moving carbon dioxide and liquid collide on the impact interface 114 at the same time, the gas-liquid mixture undergoes a higher momentum change in a short time, and the impact interface 114 forms an impact far larger than the normal pressure, thereby the solubility of the carbon dioxide dissolved in the liquid at the impact interface 114 is enhanced.

It should be noted that, in this embodiment, the impact interface 114 may be set as a hard surface, in an embodiment, the impact interface 114 may be a cavity wall of the mixing cavity 113, or as described in the following embodiments, an inner wall of the mixing cavity 113 is protruded with a rib 115, a sidewall of the rib 115 forms the impact interface 114. The specific implementation method thereof may be set according to actual needs, no limit is made here.

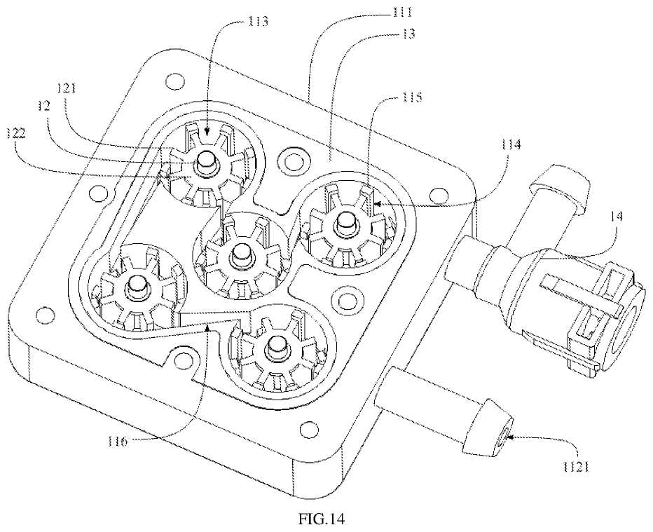

According to FIGS. 13 to 14, in some embodiments of the control method of the carbonated water machine 100 of the present application, the mixer 10 further includes an impeller 12, the impeller 12 is rotatably arranged in the mixing cavity 113, the gas-liquid inlet 1111 is arranged facing a circumferential side of the impeller 12, and the impact interface 114 is arranged on an outer side of the impeller 12 and spaced from the impeller 12, when the gas-liquid mixture is thrown from the impeller 12, it can impact on the impact interface 114.

In this embodiment, a rotating shaft 122 is arranged in the mixing cavity 113, the impeller 12 is arranged on the rotating shaft 122 and can rotate along the direction of water flow, a plurality of blades 121 are further arranged in the circumferential direction of the impeller 12, and the gas-liquid inlet 1111 is arranged on the circumferential side of the impeller 12 and is arranged in correspondence with the blades 121, when the gas-liquid mixture enters the mixing chamber 113, the gas-liquid mixture can directly impact the blades 121, in addition, the impeller 12 is driven to rotate in the direction of the fluid, whereby the impeller 12 can play a role of separating and bisecting the gas-liquid mixture, so that the carbon dioxide can be brought into full contact with the liquid, and the dissolution effect of the carbon dioxide can be improved. At the same time, the circumferential side of the impeller 12 is further provided with a plurality of impact interfaces 114, and there is a gap between the impact interfaces 114 and the impeller 12 to avoid hindering a rotation of the impeller 12. Therefore, when the rotation of the impeller 12 drives the gas-liquid mixture between the blades 121 to rotate, due to centrifugal action, the gas-liquid mixture can be thrown from the impeller 12 and can impact on the impact interface 114 arranged on the circumferential side, using the water hammer effect, a dissolution pressure much higher than the normal pressure can be obtained on the impact interface 114, so that carbon dioxide can be better dissolved in the liquid.

It should be noted that the solubility of carbon dioxide in the liquid mainly depends on the temperature of the water, the pressure of the water and a contact area with the carbon dioxide. Due to the different densities of the carbon dioxide and the liquid, the gas-liquid mixture in the mixing cavity 113 is under an action of gravity and will tend to form a stratified configuration, resulting in gas-liquid stratification, thereby reducing the total contact area between a gas phase and a liquid phase. In this embodiment, the impeller 12 is arranged in the mixing cavity 113. When the impeller 12 rotates, the blades 121 of the impeller 12 can continuously separate and divide the gas-liquid two-phase flow to destroy the gas-liquid stratification, so as to form a fine dispersion system, so that fine droplets or bubbles are evenly dispersed in a continuous phase, so that the carbon dioxide can fully contact with the liquid and improve the solubility.

According to FIGS. 13 to 14, in some embodiments of the control method of the carbonated water machine 100 of the present application, an inner wall of the mixing cavity 113 is convexly provided with ribs 115, a plurality of ribs 115 are arranged along a circumferential direction of the impeller 12, and a side wall of each rib 115 facing the impeller 12 forms the impact interface 114.

In this embodiment, an inner wall of the mixing cavity 113 is convexly provided with a plurality of ribs 115, the ribs 115 are arranged along a circumferential direction of the impeller 12, and are arranged at intervals from the impeller 12, so as to prevent the ribs from 115 obstructing the rotation of the impeller 12. the side wall of each rib 115 toward the impeller 12 is formed with an impact interface 114. In this way, when the high-speed rotating gas-liquid mixture is thrown, it can directly hit a side of a downstream rib 115, so that the gas-liquid mixture will be impacted and fused many times in the mixing cavity 113, thereby improving a solubility of carbon dioxide in the liquid.

According to FIGS. 13 to 14, in some embodiments of the control method of the carbonated water machine 100 of the present application, a plurality of mixing cavities 113 connected in sequence are formed in a shell 11, the gas-liquid inlet 1111 communicates with a mixing cavity 113 at a head end, the outlet communicates with the mixing cavity 113 at a tail end, and a impeller 12 and an impact interface 114 are disposed in each of the mixing cavities 113.

In this embodiment, a plurality of mixing cavities 113 are formed in the shell 11 sequentially, the gas-liquid inlet 1111 is in communication with the mixing cavity 113 at the head end, and the outlet is in communication with the mixing cavity 113 at the tail end, each mixing cavity 113 is provided with an impeller 12 and an impact interface 114 arranged along the circumferential direction of the impeller 12.

It can be understood that, as described in the foregoing embodiment, when the gas-liquid mixture enters the mixing chamber 113, it can drive the impeller 12 in the mixing chamber 113 to rotate in a direction of the water flow. Due to a centrifugal effect, the gas-liquid mixture will be removed from the impeller 12 and thrown out and impacted on the impact interface 114 arranged on the circumferential side of the impeller 12, and generates an instantaneous pressure several times of the normal pressure, thereby improving solubility. That is, a single mixing chamber 113 is sufficient to increase the solubility of carbon dioxide, and if multiple mixing chambers 113 are connected in series, the gas-liquid mixture entering the mixer 10 can repeat the above-mentioned process of increasing the solubility of carbon dioxide many times, thereby, carbon dioxide can be further dissolved in the liquid, and a solution with a high solute concentration is obtained.

Further, since each mixing cavity 113 carries out the above-mentioned process of improving the solubility of carbon dioxide, carbon dioxide can be continuously dissolved in the liquid, the volume of fluid in the mixing cavity 113 will be continuously reduced, and the pressure in the mixing cavity 113 will further be reduced. Therefore, when the gas-liquid mixture flows into the plurality of mixing chambers 113, the passage 116 between the mixing chambers 113 has a larger inlet and a smaller outlet. Under certain conditions, because a diameter of a pipe through which the liquid flows becomes smaller and the flow rate increases, according to Bernoulli's principle, the flow rate increases at the outlet where a cross section becomes smaller, which helps to increase a speed of the impeller 12 and a kinetic energy of the impact. Thereby improving solubility of the gas-liquid mixture in the next mixing cavity 113.

According to FIG. 14, in some embodiments of the control method of the carbonated water machine 100 of the present application, the outlet of the passage 116 is arranged toward the impeller 12 facing an outlet end of the passage 116.

In this embodiment, the passage 116 between the adjacent mixing cavities 113 is arranged toward the impeller 12 at an outlet end of the passage 116, and is substantially tangent to the impeller 12, so that the gas-liquid mixture in the upper mixing cavity 113 can directly impact on a blade 121 of the next impeller 12 along the passage 116, so as to drive the next impeller 12 to rotate, so that the gas-liquid mixture can be thrown onto the impact interface 114. It can be understood that the passage 116 is arranged tangentially with the two adjacent impellers 12, which can avoid the loss of kinetic energy of the gas-liquid mixture as much as possible, so that the impeller 12 can rotate at a high speed. In this way, the impeller 12 can effectively divide and mix the gas phase and liquid phase in the mixing cavity 113, and the gas-liquid mixture can further produce a larger instantaneous pressure when the collision is pressurized, so that achieves a good dissolution of carbon dioxide in the liquid.

Further, according to FIG. 14, in some embodiments of the control method of the carbonated water machine 100 of the present application, the cross-sectional area of the passage 116 gradually decreases along a water flow direction.

In this embodiment, the cross-sectional area of the passage 116 connecting the 113 of two adjacent mixing cavities will gradually decrease along a direction of water flow. When an inner diameter of the passage 116 gradually decreases, the liquid flow rate in the passage 116 will become faster. Therefore, the gas-liquid mixture flowing through the passage 116 has a faster flow rate and impact force, which can maintain movement in the flow direction and further accelerate, Therefore, after leaving the passage 116, the gas-liquid mixture can obtain higher kinetic energy, and when impinging on the blade 121 of the impeller 12, a rotation speed of the impeller 12 can be increased. With this arrangement, the impeller 12 can more effectively bisect and mix the gas phase and the liquid phase in the mixing cavity 113, and the gas-liquid mixture impinging on the impact interface 114 can further instantly cause a greater momentum change, so that the carbon dioxide has a better dissolution effect.

In some embodiments of the control method of the carbonated water machine 100 of the present application, the mixer 10 further includes a throttle valve, and the throttle valve is in communication with the outlet;
and/or the outlet is provided as an orifice.

In this embodiment, the mixer 10 has an outlet communicating with the mixing cavity 113, and the solution can flow out from the outlet. If the throttle valve is provided at the outlet and the throttle valve is adjusted to an appropriate opening degree, the solution flow rate discharged from the outlet can be controlled, and the high-pressure chaotic fluid pressurized in the mixer 10 can be converted into a conventional continuous fluid, this arrangement is beneficial to the distribution of the solution flowing out of the outlet by the gas, the pressure at the outlet can further be maintained, and a higher moisture pressure in the mixing cavity 113 can be ensured, thereby further improving the dissolution effect of carbon dioxide. Of course, at this time, a relatively low pressure outside the outlet, such as an atmospheric pressure, can further cause the pressure accumulated in the mixer 10 to be quickly released through the outlet, thereby improving a safety of the mixer 10.

In a feasible embodiment, the outlet can further be set as an orifice, the flow rate through the orifice can be changed by changing a flow area of the orifice, and the flow area of the orifice can be set according to parameters of the mixer 10 to control the flow rate of a solution discharged from the outlet. Therefore, the orifice can also provide a beneficial effect that can be provided by setting the throttle valve at the outlet as described in the above embodiment.

In some embodiments of the carbonated water machine 100 of the present application, the mixer 10 further includes a three-way joint 14, the three-way joint 14 includes a gas inlet joint 141, a liquid inlet joint 142, and a connecting joint 143, and the connecting joint 143 is in communication with the gas-liquid inlet 1111.

In this embodiment, the mixer 10 further includes a three-way joint 14, the three-way joint 14 is arranged outside the mixing cavity 113 and communicates with the mixing cavity 113, the three-way joint 14 includes a gas inlet joint 141, a liquid inlet joint 142 and a connecting joint 143, the connecting joint 143 is arranged at the gas-liquid inlet 1111 and communicates with the gas-liquid inlet 1111. Carbon dioxide can enter the three-way joint 14 through the gas inlet joint 141, the liquid can enter the three-way joint 14 through the liquid inlet joint 142. In this way, the gas-liquid mixture can be formed in the three-way joint 14, and the gas-liquid mixture can enter the mixing cavity 113 through the connecting joint 143.

It should be noted that the carbon dioxide supplied to the inlet joint 141 and the liquid supplied to the inlet joint 142 are at equal pressure. For example, carbon dioxide with an output pressure of 6-8 kg/cm2 can be supplied to the gas inlet joint 141, and liquid with a water pressure of 6-8 kg/cm2 can be supplied to the liquid inlet joint 142. If one of the carbon dioxide pressure or the liquid pressure is too high, a back flow of carbon dioxide or liquid may occur in the three-way joint 14, so that the gas-liquid mixture cannot enter the mixing cavity 113 and the mixer 10 cannot operate normally. Of course, in some embodiments, in order to avoid the gas-liquid back flow, an one-way valve 35 may be added to the carbon dioxide input end and the liquid input end.

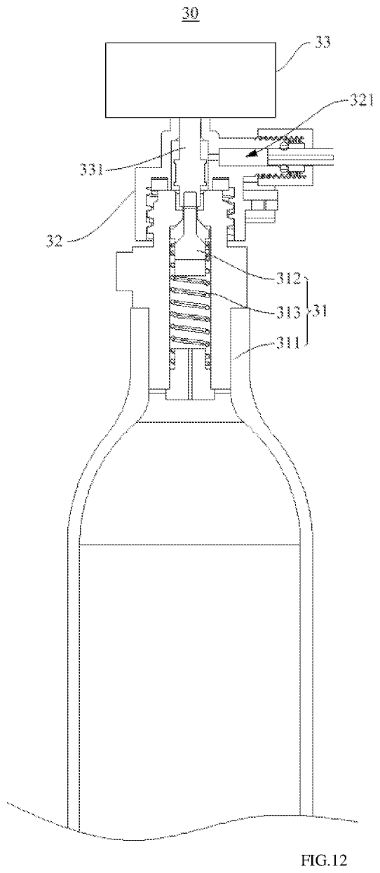

According to FIGS. 12 to 15, in some embodiments of the carbonated water machine 100 of the present application, the shell 11 includes:
an outer shell 111 forming an accommodating space with an opening, and the outer shell 111 being provided with the gas-liquid inlet 1111 and the outlet both connecting the accommodating space;
a cover body 112 covering the opening to form the mixing cavity 113 with the outer shell 111.

In this embodiment, the shell 11 includes an outer shell 111 and a cover body 112, an accommodating space is formed in the outer shell 111, the cover body 112 covers the outer shell 111 and cooperates with the outer shell 111 to form the mixing cavity 113, the outer shell 111 is further provided with the gas-liquid inlet 1111 and the outlet communicating with the mixing cavity 113, and the outer shell 111 and the cover body 112 are detachably connected, In an embodiment, the mixer 10 further includes an impeller 12, which is arranged in the accommodating space, so as to facilitate the installation of the impeller 12. The outer shell 111 may be connected to the cover body 112 by screws, and may either be connected to the cover body 112 by fasteners such as bolts in the following embodiments, which are not described herein.

In a feasible embodiment, the cover body 112 and the outer shell 111 are fixedly connected by bolts, the cover body 112 is provided with a counterbore larger than an outer diameter of the bolts, and a surface of the outer shell 111 facing the cover body 112 is correspondingly provided with a screw hole, and the bolts can be arranged in the counterbore and threaded connection with the outer shell 111, thereby locking the cover body 112 on the outer shell 111. In this way, the shell 11 has a stable installation structure, so as to have better stability and reliability.

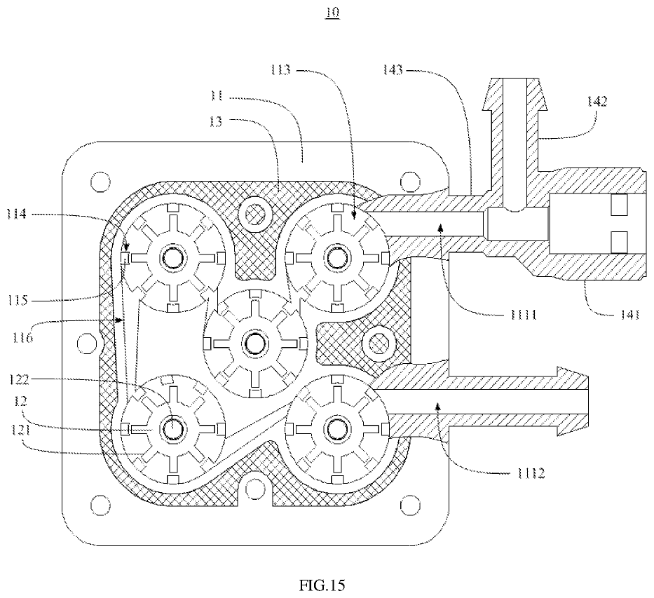

According to FIGS. 14 and 15, in some embodiments of the carbonated water machine 100 of the present application, the mixer 10 further includes a sealing member 13, which is arranged around a periphery of the opening and is sandwiched between the outer shell 111 and the cover body 112.

In this embodiment, the cover body 112 and the outer shell 111 are enclosed to form the mixing cavity 113, and a sealing member 13 is arranged between the cover body 112 and the outer shell 111, and the sealing member 13 is arranged around an edge of the mixing cavity 113, this arrangement can make the mixer 10 has better air tightness, avoids air leakage or liquid leakage, and can ensure the pressure in the mixing cavity 113, thereby improving the dissolution effect of carbon dioxide.

In a feasible embodiment, the sealing member 13 is provided with a through hole, and the bolt described in the above embodiment can be connected to the outer shell 111 through the through hole, so that the sealing member 13 is firmly installed between the outer shell 111 and the cover body 112, in this way, the sealing member 13 can be fixed to improve the position stability of the sealing member 13, and prevent the sealing member 13 from slipping or loosening, thereby ensuring the sealing performance of the mixer 10. In some embodiments, a groove can further be provided on the surface of the outer shell 111 facing the cover body 112, the groove is arranged around the periphery of the mixing cavity 113, and the sealing member 13 is arranged in the groove and abuts against a surface of the cover body 112 facing the outer shell. Of course, the groove can be either provided on the cover body 112, the sealing member 13 is provided in the groove and abuts against the surface of the outer shell 111 facing the cover body 112. The specific embodiment can be set according to the actual needs, and is not limited here.

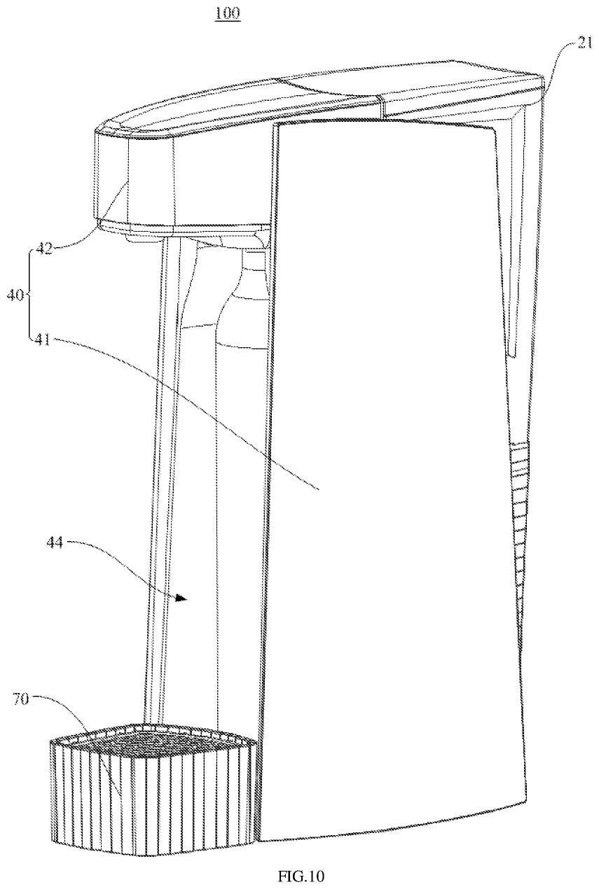

According to FIG. 10, in some embodiments of the carbonated water machine 100 of the present application, the carbonated water machine 100 further includes a bubbler 50, and the bubbler 50 is disposed at the flow outlet.

In this embodiment, the carbonated water machine 100 further includes the bubbler 50 arranged at the flow outlet. An input port of the bubbler 50 is a wedge-shaped inlet from large to small, so that the mixed carbonated water flowing through the bubbler 50 receives a certain resistance, which plays a role of throttling. At the same time, after the carbonated water is buffered by the bubbler 50, a flow rate of the carbonated water can be reduced, avoiding greater impact on users when taking water.

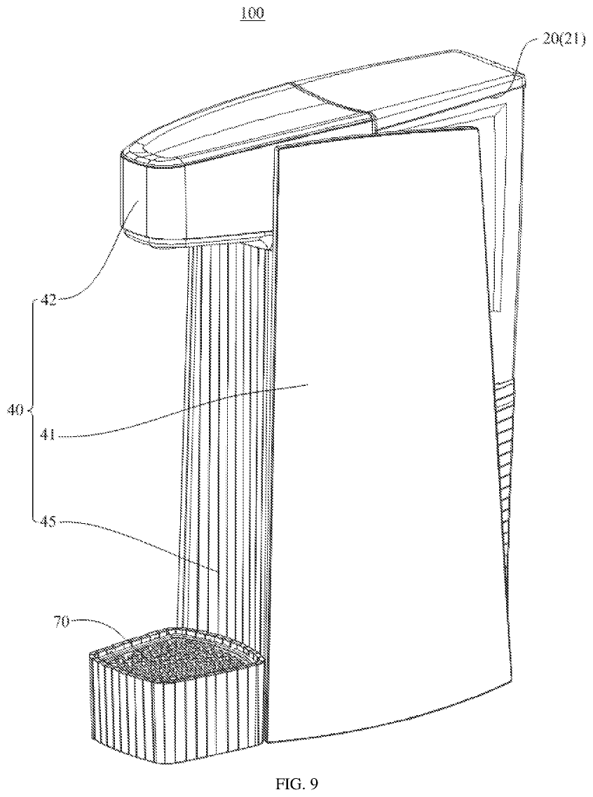

According to FIGS. 9 and 10, in an embodiment of the control method of the carbonated water machine 100 of the present application, the liquid supply assembly 20 includes a water tank 21, a water pump 22 and a three-way control valve 23, the three-way control valve 23 has a water inlet, a first water outlet and a second water outlet, the water inlet is communicated with the water tank 21 through the water pump 22, and the first water outlet is communicated with the water tank 21, the second water outlet is in communication with the gas-liquid inlet 1111.

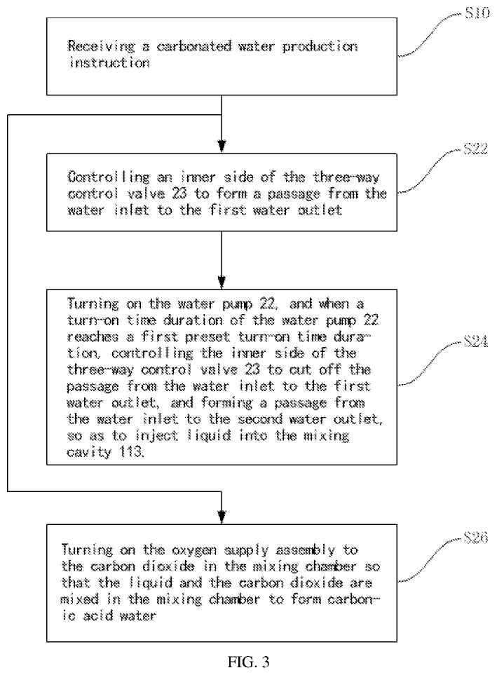

According to FIG. 3, the operation of opening the liquid supply assembly 20 to inject liquid into the mixing cavity 113 includes:

Operation S22, controlling an inner side of the three-way control valve 23 to form a passage from the water inlet to the first water outlet.

Operation S24, turning on the water pump 22, and when a turn-on time duration of the water pump 22 reaches a first preset turn-on time duration, controlling the inner side of the three-way control valve 23 to cut off the passage from the water inlet to the first water outlet, and forming a passage from the water inlet to the second water outlet, so as to inject liquid into the mixing cavity 113.

In this embodiment, the liquid supply assembly 20 includes a water tank 21, a water pump 22, and a three-way control valve 23, so that the water inlet and the first water outlet of the three-way control valve 23 are in communication with the water tank 21, and the second water outlet is in communication with the gas-liquid inlet 1111 of the mixer 10. The three-way control valve 23 is mostly a solenoid valve, which can switch the water outlets communicated with the water inlet, the liquid circulates between the water tank 21, the water pump 22 and the three-way control valve 23 to prevent the liquid remaining in the pipeline from flowing to the mixer 10 first. At the same time, the factors that affect the solubility of carbon dioxide in the liquid mainly include temperature, gas-liquid pressure, and gas-liquid contact area. Among them, the lower the temperature, the higher the solubility of carbon dioxide, at this time, the water tank 21 can be injected with cold water below 6 degrees or ice-water mixture, after the liquid circulates among the water tank 21, the water pump 22 and the three-way control valve 23 for a certain period to make the water flowing to the mixer 10 is cold water at a preset temperature, thereby improving the solubility of carbon dioxide. When a turn-on time duration of the water pump 22 reaches a preset turn-on time duration, the three-way control valve 23 is controlled, so that the passage between the water inlet and the first water outlet is closed, the passage between the water inlet and the second water outlet is opened, and the gas supply assembly 30 is simultaneously turned on, so that the carbon dioxide and the liquid in the water tank 21 are injected into the mixing cavity 113 and mixed to form carbonated water.

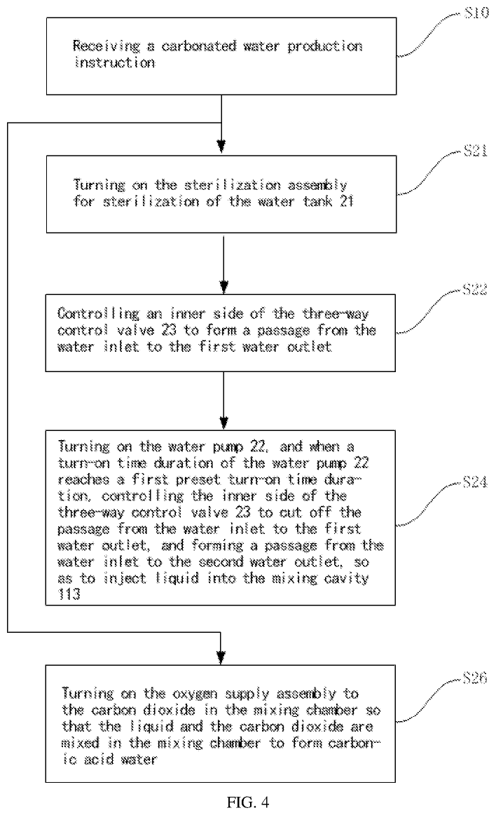

According to FIG. 4, in an embodiment of the control method of the carbonated water machine 100 of the present application, the carbonated water machine 100 further includes a sterilization assembly, the sterilization assembly is configured for sterilizing the water tank 21, and the control of the three-way control valve 23, before the operation of forming the passage from the water inlet to the first water outlet, it further includes:
operation 521, turning on the sterilization assembly for sterilization of the water tank 21.

In this embodiment, a sterilization assembly is arranged in the carbonated water machine 100, and the sterilization assembly can be used to sterilize the water tank 21 and the liquid in the water tank 21, so as to prevent the growth of bacteria in the water tank 21 from affecting the drinking of carbonated water and human health. In particular, The sterilization assembly may be ultraviolet sterilization, or may be high-temperature sterilization or a combination of multiple sterilization methods. When the processor receives an input sterilization instruction, the processor controls the sterilization assembly to start to sterilize the water tank 21. It should be noted that, in this embodiment, the gas supply assembly 30 is made to open the sterilization assembly before supplying water to the mixer 10, and the sterilization assembly can be kept in an turn-on state during the carbonated water production process, the sterilization assembly can either be turned on for a certain period of time duration or intermittently turned on. The input of the sterilization instruction can be input by the user or automatically generated when certain conditions are met. For example, when the carbonated water production instruction is input, the sterilization instruction is generated synchronously, or when water is added to the water tank 21, or when the water tank 21 is installed to the carbonated water machine 100, which are not limited here. Of course, the operation mode of the sterilization assembly can be set according to their respective requirements, which can be set during the production of the carbonated water machine 100 or set by the user himself.

In some embodiments, a side of the main part 41 of the machine base 40 away from the extension part 42 is provided with a clamping slot for installing the water tank 21. Specifically, a limit bracket for placing the water tank 21 is provided in the mounting cavity 44, and a limit port connected to the mounting cavity 44 is opened on the side of the main part 41 away from the extension part 42, the limit port can be opened on at least one of the top and the side of the main body 41, and is arranged toward the limit bracket. At this time, the water tank 21 can be inserted into the limit bracket from the limit port to improve the stability of the installation of the water tank 21 in the machine base 40, and when the water tank 21 is stuck in the limit bracket, part of the water tank 21 is exposed from the limit port, which is convenient for the users to take out or put in the water tank 21.

In some embodiments, the water tank 21 includes a tank body and a tank cover that covers an opening at the top of the tank body, and the tank cover protrudes from the top opening of the main part 41, so that the water tank 21 can be charged with water by opening the tank cover, without repeatedly taking out the water tank 21, thereby improving the convenience of use.

In some embodiments, the water tank 21 is disposed above the water pump 22 to make reasonable use of a space in the mounting cavity 44 and reduce a volume of the carbonated water machine 100.

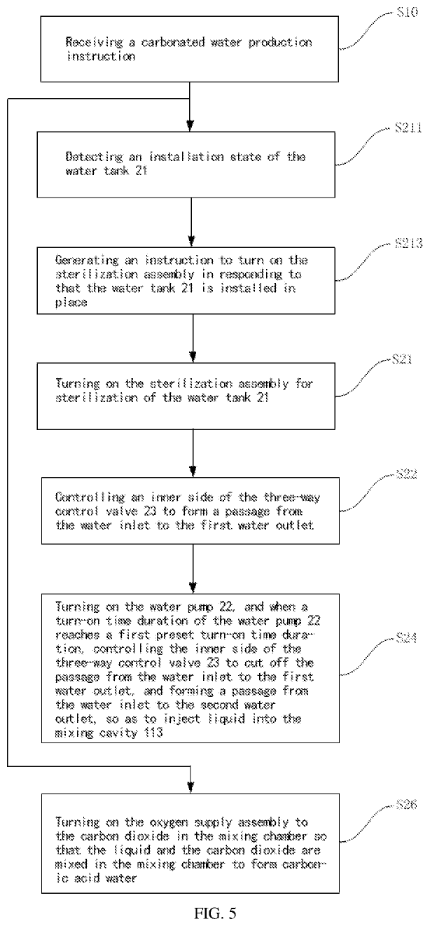

According to FIG. 5, based on the above hardware architecture, in an embodiment of the control method of the carbonated water machine 100 of the present application, the operation of turning on the sterilization assembly further includes:
operation S211, detecting an installation state of the water tank 21;
operation S213, generating an instruction to turn on the sterilization assembly in responding to that the water tank 21 is installed in place.

In this embodiment, the water tank 21 can be detachably arranged to facilitate cleaning and maintenance of the water tank 21. At this time, after the water tank 21 is re-installed on the machine base, an installation state of the water tank 21 can be detected by a position detector a pressure sensor, a proximity switch, or the like, or directly a switch of the sterilization assembly is provided on an installation position of the water tank 21, when the water tank 21 is installed in place, the instruction to turn on the sterilization assembly to sterilize the water tank 21 is directly generated, the structure is simple, and the operation is easy.

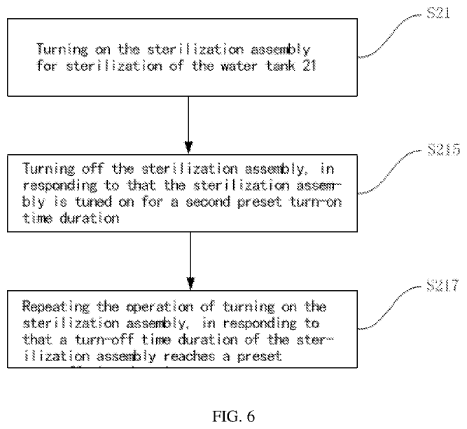

According to FIG. 6, in an embodiment of the control method of the carbonated water machine 100 of the present application, after the operation of turning on the sterilization assembly, the method further includes:
operation S215, turning off the sterilization assembly, in responding to that the sterilization assembly is tuned on for a second preset turn-on time duration;
operation S217, repeating the operation of turning on the sterilization assembly, in responding to that a turn-off time duration of the sterilization assembly reaches a preset turn-off time duration.

In this embodiment, when the water tank 21 is sterilized by the sterilizing assembly, the sterilizing assembly is controlled to be activated periodically. Specifically, a preset turn-on time duration and a preset turn-off time duration of the sterilization assembly are preset in the control method. After the sterilization assembly is controlled to be turned on, a clock module on the main board detects and obtains the turn-on time duration of the sterilization assembly. When the turn-on time duration reaches the preset turn-on time duration preset by the system, the sterilization assembly is controlled to be turned off. Then, the clock module detects and obtains the turn-off time duration of the sterilization assembly, when the turn-off time duration of the sterilization assembly is up to the preset turn-off time duration, the sterilization assembly is turned on again and the previous operation is repeated. This arrangement can not only avoid excessive energy consumption caused by long-term use of the sterilization assembly, but further ensure continuity of sterilization of the water tank 21, so as to improve the use safety of the carbonated water machine 100. It should be noted that, in this embodiment, the sterilization assembly is operated in a cycle of turning on and off. At this time, the liquid supply assembly 20 may be caused to inject liquid into the mixer 10 within any time after the sterilization assembly is turned on for the first time, which is not limited here.

In an embodiment of the control method of the carbonated water machine 100 of the present application, in the operation of turning on the liquid supply assembly 20 to inject liquid into the mixing cavity 113 and turning on the gas supply assembly 30 to inject carbon dioxide into the mixing cavity 113, the liquid supply assembly 20 and the gas supply assembly 30 are controlled to inject liquid and carbon dioxide within a same pressure range into the mixing cavity 113.

In this embodiment, the carbon dioxide provided by the gas supply assembly 30 is within a same pressure range as the liquid provided by the liquid supply assembly 20. It can be understood that if the pressure of carbon dioxide or one of the liquid pressure is too large, it is possible that carbon dioxide or liquid back flow phenomenon may occur, or the relatively low pressure carbon dioxide or liquid cannot enter the mixing cavity 113, and the mixer 10 cannot work normally. Of course, in some embodiments, in order to avoid gas-liquid backflow, the one-way valve 35 may be added to the carbon dioxide input end and the liquid input end.

In an embodiment of the control method of the carbonated water machine 100 of the present application, a pressure range of the liquid supplied from the liquid supply assembly 20 to the mixing cavity 113 and a pressure range of the carbon dioxide supplied from the gas supply assembly 30 to the mixing cavity 113 are 6 kg/cm2 to 8 kg/cm2.

In this embodiment, the water and gas pressures injected into the mixing cavity 113 by the liquid supply assembly 20 and the gas supply assembly 30 are within a pressure range of 6 kg/cm2 to 8 kg/cm2. At this time, the liquid and the gas are kept within a certain pressure range after being injected into the mixing cavity 113, which can promote a better dissolution of carbon dioxide in the liquid, moreover, the liquid and gas pressure will not reach 500 kg/cm² like the traditional way of impacting liquid or carbon dioxide with high pressure in the pressure tank, and a safety of the carbonated water preparation process is highly guaranteed.

It should be noted that, in this embodiment, the liquid and the gas respectively reach a pressure range of 6 kg/cm² to 8 kg/cm². It can be understood that the liquid supply assembly 20 supplies liquid to the mixer 10 by pumping the liquid in the water tank 21 from the water pump 22. At this time, the water pump 22 can pressurize the liquid to make the liquid reach the pressure range of 6 kg/cm² to 8 kg/cm², and the common carbon dioxide supply is generally using the gas cylinder 31, the gas cylinder 31 is filled with liquefied carbon dioxide. When the gas cylinder 31 releases carbon dioxide, the liquid carbon dioxide is vaporized into gaseous carbon dioxide. Under normal circumstances, the pressure of gaseous carbon dioxide released by the gas cylinder 31 is much higher than 6 kg/cm2 to 8 kg/cm2. At this time, the high-pressure gas can be decompressed by setting a pressure reducing valve 34, or the gas flow path can be gradually increased to realize decompression, So that carbon dioxide reaches the pressure range of 6 kg/cm2 to 8 kg/cm2. It can be understood that the use of the water pump 22 to extract liquid to pressurize the liquid and the use of the pressure reducing valve 34 to reduce the pressure of the gas can be adjusted according to the requirements of the air pump and the pressure reducing valve 34 to obtain the required gas pressure and liquid pressure. Of course, in some embodiments, if an initial gas pressure of the gas supply assembly 30 is too small, a pressure increasing valve may further be used to pressurize, which is not limited here.

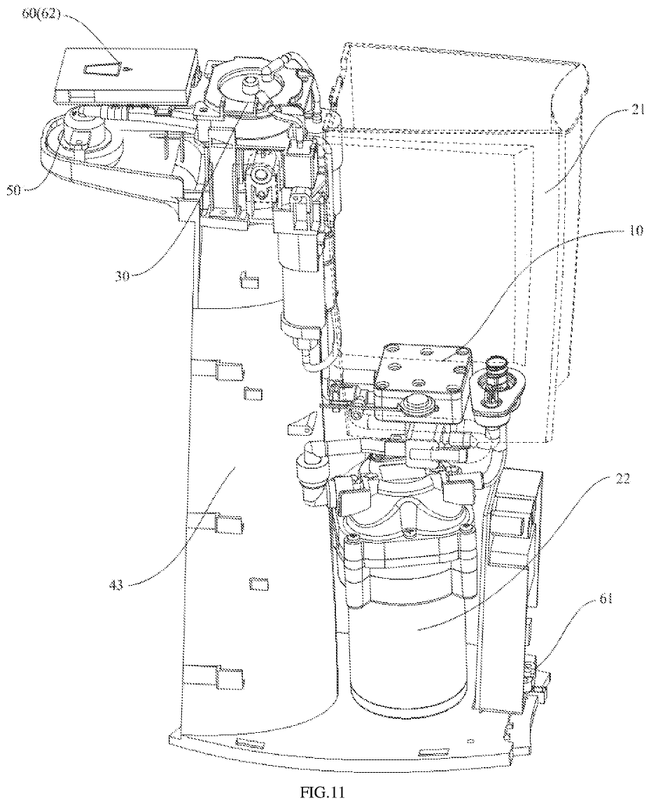

According to FIG. 11, in some embodiments of the carbonated water machine 100 of the present application, the gas supply assembly 30 includes:
a gas cylinder 31 vertically arranged in the mounting cavity 44;
a gas cylinder connector 32 covers a valve on a top of the gas cylinder 31, and the gas cylinder connector 32 being provided with a gas outlet 321; and
an ejector mechanism 33, where the ejector mechanism 33 is arranged above the gas cylinder connector 32, and an ejector rod 331 of the ejector mechanism 33 is extendable, and one end of the ejector rod 331 is extended through the gas cylinder connector 32 and abuts against the valve of the gas cylinder 31, so as to open and close the valve during the extension and retreat process.

In this embodiment, the gas supply assembly 30 includes a gas cylinder 31, the gas cylinder 31 includes a cylinder body 311, an opening of the cylinder body 311 is inserted with a movable ejector rod 312 to form a valve, specifically, the movable ejector rod 312 is located in the cylinder body 311. an outer wall of one end of the movable ejector rod 312 is provided with a stopper to close the opening of the cylinder body 311, and a gas outlet gap is provided between a side wall of the movable ejector rod 312 and an opening edge of the cylinder body 311. When the gas cylinder 31 is not needed to be opened, the movable ejector rod 312 has a tendency to extend outward by an action of a spring or a reset member 313, so that the stopper closes the opening of the cylinder body 311. When the gas cylinder 31 is needed to be opened, the movable ejector rod 312 is retreated inward to make the stopper away from the opening. At this time, the carbon dioxide in the cylinder 31 can be discharged from the gas outlet gap between the movable ejector rod 312 and the edge of the opening. In this embodiment, the gas cylinder 31 further includes a gas cylinder connector 32 and an ejection mechanism 33, the gas cylinder connector 32 is approximately in the shape of a shell, the gas cylinder connector 32 is covered at the bottle mouth of the gas cylinder 31, the gas cylinder connector 32 is approximately provided with a gas outlet 321 for communicating with the mixer 10 at the side, and the ejector rod 331 of the ejection mechanism 33 is disposed through the outer end of the gas cylinder connector 32, when the ejector rod 331 of the ejector mechanism 33 is extended, the movable ejector rod 312 can be ejected into the cylinder 31 to open the cylinder 31, so that carbon dioxide enters the cylinder connector 32 and flows from the gas outlet 321 to the mixer 10. When the ejector rod 331 of the ejector mechanism 33 is retracted, the movable ejector rod 312 can be reset under the action of a spring or another reset member 313 to close the cylinder 31. In this embodiment, the ejector mechanism 33 controls the retraction of the ejector rod 331, which may be driven by a cylinder, or may be driven by a motor and a mechanical transmission mechanism, which is not limited here.

In some embodiments, the ejection mechanism 33 is a cylinder, the piston of the cylinder serves as the ejector rod 331, the intake port of the cylinder is communicated with an air pump 333, and the air outlet of the cylinder is provided with an air valve 332. Under normal conditions, the air valve keep it normally open, so that the air outlet of the cylinder is connected to the external environment, and keep the ejector rod 331 retracted. When the cylinder 31 needs to be opened, the ejector rod 331 is ejected to push the movable ejector rod 312 into the gas cylinder 31 to open the gas cylinder 31, so that carbon dioxide enters the gas cylinder connector 32 and flows from the gas outlet 321 to the mixer 10. When the gas pump 333 is closed and the gas valve 332 is opened, the cylinder is exhausted, the ejector rod 331 retracts, and the movable ejector rod 312 can be reset under the action of the spring or another reset member 313.

According to FIG. 10, in some embodiments of the carbonated water machine 100 of the present application, the machine base 40 further includes a gas cylinder bracket 43, the gas cylinder bracket 43 is disposed in the mounting cavity 44 and formed with a limiting space, and the gas cylinder 31 is limited in the limiting space.

In this embodiment, the gas cylinder bracket 43 is arranged in the mounting cavity 44, and the gas cylinder bracket 43 forms a limiting space for limiting the gas cylinder 31, so as to improve the installation stability of the gas cylinder 31. At this time, the gas cylinder connector 32 can be fixedly connected with the gas cylinder bracket 43, and the gas cylinder 31 can be replaced only by disassembling the gas cylinder 31 from the gas cylinder connector 32, without removing the entire gas supply assembly 30, thereby improving ease of use. The arrangement of the cylinder holder 43 can further separate the liquid supply assembly 20 and the water supply assembly to avoid interference between the liquid supply assembly 20 and the water supply assembly.

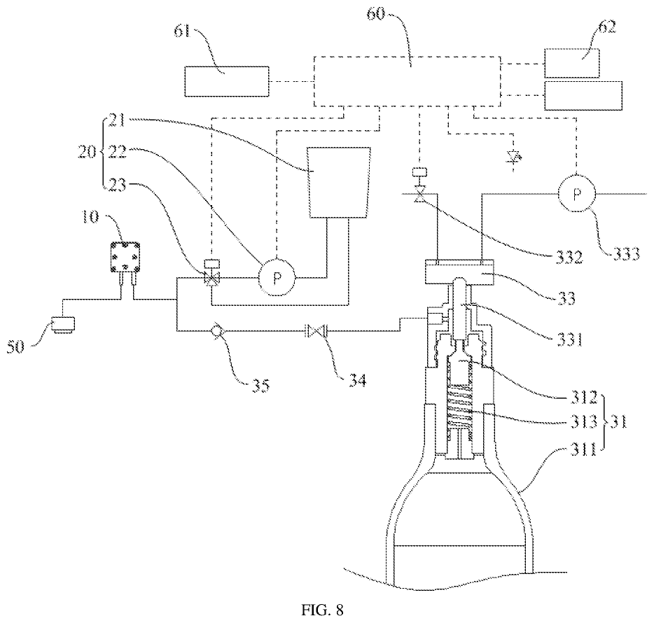

According to FIGS. 8 and 9, in some embodiments of the carbonated water machine 100 of the present application, a side wall of the main part 41 is provided with a mounting opening communicating with the mounting cavity 44, the mounting opening is arranged toward the gas cylinder 31, the machine base 40 further includes a side cover plate 45, and the side cover plate 45 is arranged to cover the mounting opening.

In this embodiment, a side wall of the main part 41 is provided with a mounting opening facing the gas cylinder 31, and the user can disassemble and assemble the gas cylinder 31 from the mounting opening to improve the convenience of use. In order to prevent foreign objects from entering the mounting cavity 44 when the gas cylinder 31 does not need to be disassembled and assembled, the mounting opening is covered with a side cover plate 45 to close the mounting cavity 44 when the gas cylinder 31 does not need to be disassembled, improving the safety of the carbonated water machine 100.

In some embodiments of the carbonated water machine 100 of the present application, an one-way valve 35 is provided between the gas outlet 321 and the gas-liquid inlet 1111.

It can be understood that if the carbon dioxide pressure of the input mixer 10 is less than the liquid pressure of the input mixer 10, or the gas outlet 321 of the gas supply assembly 30 is not closed in time, the liquid can be poured back into the gas supply assembly 30. In this embodiment, an one-way valve 35 is arranged between the gas outlet 321 of the gas supply assembly 30 and the gas-liquid inlet 1111 of the mixer 10, it can effectively prevent the mixed carbonated water or the liquid of the liquid supply assembly 20 from entering the gas supply assembly 30 and causing the carbonated water machine 100 to fail.

According to FIGS. 8 and 9, in some embodiments of the carbonated water machine 100 of the present application, the carbonated water machine 100 further includes a water receiving tray 70, and the water receiving tray 70 is disposed below the flow outlet and spaced apart from the flow outlet.

In this embodiment, the machine base 40 further includes a water receiving tray 70, the water receiving tray 70 is disposed below the flow outlet, and is spaced apart from the flow outlet to form a water receiving space, so that the user's cup or other container can be placed below the flow outlet, and the water receiving tray 70 is disposed to avoid the moisture of a bearing surface on which the carbonated water machine 100 is placed due to the sprinkling of carbonated water.

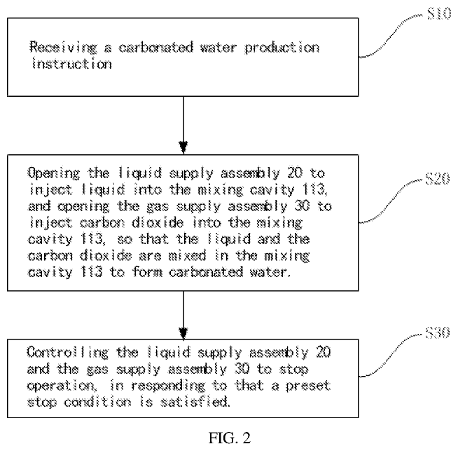

According to FIG. 2, in an embodiment of the control method of the carbonated water machine 100 of the present application, after the operation of turning on the liquid supply assembly 20 to inject the liquid into the mixing cavity 113, and turning on the gas supply assembly 30 to inject the carbon dioxide into the mixing cavity 113, so that the liquid and the carbon dioxide are mixed in the mixing cavity 113 to form the carbonated water, the method further includes:
operation S30, controlling the liquid supply assembly 20 and the gas supply assembly 30 to stop operation, in responding to that a preset stop condition is satisfied.

The technical scheme of the present application uses instant mixing to make carbonated water. When the user has received enough carbonated water, a carbonated water production stop instruction can be input to the carbonated water machine 100 through the control structure or terminal on the carbonated water machine 100, or a carbonated water production time duration can be preset, and the carbonated water production stop instruction can be generated when the preset production time duration is expired, it can further automatically sense and generate the carbonated water production stop instruction through a liquid level sensor or another method. When the processor receives the carbonated water production stop instruction to stop the production of carbonated water, the processor controls the liquid supply assembly 20 and the water supply assembly to stop operation, so that the liquid supply assembly 20 and the gas supply assembly 30 no longer provide liquid and carbon dioxide to the mixer 10, and the production and output of carbonated water is stopped.

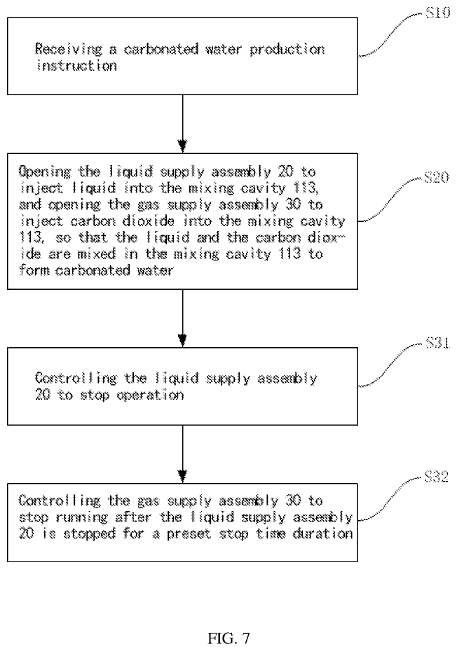

According to FIG. 7, in an embodiment of the control method of the carbonated water machine 100 of the present application, the operation of controlling the liquid supply assembly 20 and the gas supply assembly 30 to stop operation includes:
operation S31, controlling the liquid supply assembly 20 to stop operation.
operation S32: controlling the gas supply assembly 30 to stop running after the liquid supply assembly 20 is stopped for a preset stop time duration.

In this embodiment, when the processor receives a carbonated water production stop instruction to stop the production of carbonated water, the processor firstly controls the water pump 22 to stop running. At this time, the liquid supply assembly 20 stops injecting liquid into the mixer 10 but the gas supply assembly 30 still supplies gas to the mixer 10 to completely discharge the liquid in the mixer 10 and the pipeline, so as to avoid the liquid remaining in the mixer 10 and the pipeline, and ensure the use hygiene of the carbonated. The preset stop time duration can be set according to actual requirements, which can be set during the production of the carbonated water machine 100 or set by the user himself, which is not limited here.

According to FIGS. 8 to 10, the present application further provides a carbonated water machine 100. The carbonated water machine 100 includes a mixer 10, a liquid supply assembly 20, and a gas supply assembly 30. A mixing cavity 113 is formed in the mixer 10. The mixer 10 is provided with a gas-liquid inlet 1111 and an outlet 1112 connected to the mixing cavity 113, a liquid outlet of the liquid supply assembly 20 and a gas outlet 321 of the gas supply assembly 30 are both in communication with the gas-liquid inlet 1111, the carbonated water machine 100 further includes a memory, a processor and a control method of the carbonated water machine 100 stored in the memory and executable by the processor, and the processor implements the control method of the carbonated water machine 100 as described in the above when executing the control method of the carbonated water machine 100.

In addition, in order to achieve the above object, another aspect of the present application further provides a computer-readable storage medium, on which a control method of a carbonated water machine 100 is stored, when the control method of the carbonated water machine 100 is executed by a processor, the control method of the carbonated water machine 100 described in the above is implemented.

Those skilled in the art will appreciate that embodiments of the present application may be provided as methods, systems, or computer program products. Therefore, the present application may take the form of an embodiment with only hardware, an embodiment with only software, or an embodiment combining software and hardware. Moreover, this application may take the form of a computer program product implemented on one or more computer-usable storage media (including, but not limited to, the disk storage, the CD-ROM, the optical storage, etc.) containing computer-usable program code.

The present application is described with reference to flow charts and/or block diagrams of methods, devices (systems), and computer program products according to embodiments of the present application. It should be understood that each process and/or box in the flow chart and/or block diagram, as well as the combination of processes and/or boxes in the flow chart and/or block diagram, can be implemented by computer program instructions. These computer program instructions may be provided to a processor of a general purpose computer, a special purpose computer, an embedded processor, or another programmable data processing device to generate a machine such that the instructions executed by the processor of the computer or other programmable data processing device generate means for implementing the functions specified in a process or processes of a flowchart and/or a block or blocks of a block diagram.

These computer program instructions can also be stored in a computer-readable memory that can guide a computer or other programmable data processing equipment to work in a specific way, so that the instructions stored in the computer-readable memory produce a manufacturing article including an instruction device, which implements the functions specified in one or more processes of a flow chart and/or one or more boxes of a block diagram.

These computer program instructions may also be loaded onto a computer or other programmable data processing device such that a series of operational steps are performed on the computer or other programmable device to produce a computer-implemented process, whereby the instructions executed on the computer or other programmable device provide steps for implementing the functions specified in a flow or flows of a flow chart, and/or a block or blocks in a block diagram.

It should be noted that in the claims, any reference symbols located between parentheses should not be constructed to limit the claims. The word “comprising” does not preclude the existence of parts or steps that are not listed in the claims. The word “one” or “a/an” before the part does not exclude the existence of multiple such parts. the present application can be implemented by means of hardware including several different assemblies and by means of a properly programmed computer. In the unit claims enumerating several devices, several of these devices may be embodied by the same hardware item. The use of word target, second, and third, etc. does not indicate any order. These words can be interpreted as names.

Although preferred embodiments of the present application have been described, those skilled in the art may make additional changes and modifications to these embodiments once the basic inventive concepts are known. Therefore, the appended claims are intended to be interpreted to include the preferred embodiments and all changes and modifications falling within the scope of the present application.

It is clear that those skilled in the art may make various changes and variations to the present application without departing from the spirit and scope of the present application. Thus, if these modifications and modifications of the present application fall within the scope of the claims of the present application and their equivalent technologies, the present application is further intended to include these modifications and modifications.

What is claimed is:

1. A control method of a carbonated water machine, wherein the carbonated water machine comprises a mixer, a liquid supply assembly, and a gas supply assembly, a mixing cavity is formed in the mixer, and the mixer is provided with a gas-liquid inlet and an outlet connecting with the mixing cavity, a liquid outlet of the liquid supply assembly and a gas outlet of the gas supply assembly are both communicated with the gas-liquid inlet, and the control method of the carbonated water machine comprises:
receiving a carbonated water production instruction; and
turning on the liquid supply assembly to inject liquid into the mixing cavity, and turning on the gas supply assembly to inject carbon dioxide into the mixing cavity, so that the liquid and the carbon dioxide are mixed in the mixing cavity to form carbonated water.

2. The control method of the carbonated water machine according to claim 1, wherein the liquid supply assembly comprises a water tank, a water pump and a three-way control valve, the three-way control valve is configured with a water inlet, a first water outlet and a second water outlet, the water inlet is connected to the water tank through the water pump, the first water outlet is connected to the water tank, and the second water outlet is connected to the gas-liquid inlet;
wherein the operation of opening the liquid supply assembly to inject liquid into the mixing cavity comprises:
controlling an inner side of the three-way control valve to form a passage from the water inlet to the first water outlet;
turning on the water pump, controlling the inner side of the three-way control valve to cut off the passage from the water inlet to the first water outlet in responding to that the water pump is turned on for a first preset turn-on time duration, and forming a passage from the water inlet to the second water outlet to inject the liquid into the mixing cavity.

3. The control method of the carbonated water machine according to claim 2 the passage from the water inlet to the first water outlet further comprises:
turning on a sterilization assembly to sterilize the water tank.

4. The control method of the carbonated water machine according to claim 3, wherein, after the operation of turning on the sterilization assembly, the method further comprises:
detecting an installation state of the water tank;
generating an instruction to turn on the sterilization assembly in responding to that the water tank is installed in place.

5. The control method of the carbonated water machine according to claim 3, wherein, after the operation of turning on the sterilization assembly, the method further comprises:
turning off the sterilization assembly in responding to that the sterilization assembly is turned on for a second preset turn-on time duration;
repeating the operation of turning on the sterilization assembly in responding to that the sterilization assembly is turned off for a preset turn-off time duration.

6. The control method of the carbonated water machine according to claim 1, wherein in the operation of turning on the liquid supply assembly to inject the liquid into the mixing cavity and tuning on the gas supply assembly to inject the carbon dioxide into the mixing cavity, the liquid injected by the liquid supply assembly into the mixing cavity and the carbon dioxide injected by the gas supply assembly are within a same pressure range.

7. The control method of the carbonated water machine according to claim 6, wherein a pressure range of the liquid and the carbon dioxide injected into the mixing cavity is 6 kg/cm2 to 8 kg/cm2.

8. The control method of the carbonated water machine according to claim 7, wherein after the operation of turning on the liquid supply assembly to inject the liquid into the mixing cavity and turning on the gas supply assembly to inject the carbon dioxide into the mixing cavity, so that the liquid and the carbon dioxide are mixed in the mixing cavity to form the carbonated water, the method further comprises:
controlling the liquid supply assembly and the gas supply assembly to stop operation in responding to that a preset stop condition is met.

9. The control method of the carbonated water machine according to claim 8, wherein the operation of controlling the liquid supply assembly and the gas supply assembly to stop operation comprises:
controlling the liquid supply assembly to stop operation;
controlling the gas supply assembly to stop operation after the liquid supply assembly is stopped for a preset stop time duration.

10. A carbonated water machine, wherein the carbonated water machine comprises a mixer, a liquid supply assembly and a gas supply assembly, a mixing cavity is formed in the mixer, and the mixer is provided with a gas-liquid inlet and an outlet both communicating with the mixing cavity, and a liquid outlet of the liquid supply assembly and a gas outlet of the gas supply assembly are both connected with the gas-liquid inlet;
wherein the carbonated water machine further comprises a memory, a processor, and a control program of the carbonated water machine stored in the memory and operable on the processor, and when the control program of the carbonated water machine is executed by the processor, the processor implements the control method of the carbonated water machine according to claim 1.
